(19) United States
(12) Patent Application Publication
(10) Pub. No.: US 2009/0206271 A1
(43) Pub. Date: Aug. 20, 2009

(54) FOCUSSING MASK

(75) Inventor: Derek Anthony Eastham, Chester (GB)

Correspondence Address: JAMES D. STEVENS;REISING ETHINGTON P.C., P.O. BOX 4390, TROY, MI, 48099, US

(73) Assignee: NFAB LIMITED, St Asaph (GB)

(21) Appl. No.: 11/719,181

(22) PCT Filed: Nov. 17, 2005
(86) PCT No.: PCT/GB05/04435

§ 371 Date: Apr. 23, 2009

(30) Foreign Application Priority Data
Nov. 17, 2004 (GB) 0425290.4

(51) Int. Cl. H01J 3/14

(52) U.S. Cl. 250/396 R

(57) ABSTRACT

A mask suitable for use with a particle beam source such as ion or electron source for forming features and structures and writing on surfaces of materials. The mask comprising an aperture plate, having a plurality of apertures, and focusing means disposed to underlie the aperture plate. The plurality of apertures forming an array whereby each plate aperture is adapted to receive a portion of a particle beam incident on the aperture plate. Each portion of particle beam then passes through focusing means through which the portion of beam is focused onto the surface. The mask thereby forming a plurality of high resolution simultaneously operable focused particle beams.

The present invention relates to direct write apparatus and methods such as, for example, ion beam milling (sputtering) using ions, and material surface modification apparatus and methods such as, for example, polymerisation and surface oxidisation, using electrons, and particularly to apparatus and methods for rapid production of nanostructures and nanostructured surfaces, and more particularly to masks used in the above-mentioned methods.

In general there are two characteristics which determine the performance of apparatus and methods which use energetic focused particle beams. The first is the size of the beam-spot which determines the smallest feature which can be made. Known high-resolution scanning electron beam (lithography) apparatus have resolutions of, at best, 1 nm and can form features on surfaces by standard lithographic techniques of about 30 nm. Similarly, known ion beam milling machines, which use a single beam, have a resolution of about 30 nm and produce surface features, by sputtering, comparable to this.

The second characteristic is the intensity of the beam which determines the rate at which the machine can produce, by scanning, patterned surfaces of useful practical size. This is probably anything greater than 1×1 mm².

However, the intensity of the beam is related to the resolution and it is only possible to get the best resolution when the beam is extremely small and consequently the writing speed is very slow.

It is therefore desirable for there to be apparatus and methods which provide high resolution whilst simultaneously providing relatively rapid production of features on surfaces.

According to the present invention there is provided a mask, suitable for use with a particle beam source, comprising an aperture plate having a plurality of apertures therein, each aperture adapted to receive a portion of a particle beam incident on the aperture plate, and focusing means operable to focus each said portion of a said particle beam onto a surface of material on which it is desired to write.

The focusing means may be operable to focus each portion of particle beam to a diameter of approximately 10 nm, or less.

The size of each plate aperture may be in the range of between 20 nm and 200 μm, and is preferably approximately 1 μm.

The focusing means may comprise a plurality of spaced apart electrically conductive elements, which may be disposed to underlie the aperture plate in parallel arrangement therewith. The focusing means having a plurality of focusing apertures, extending through the electrically conductive elements, each focusing aperture corresponding to one of the plurality of the plate apertures and sharing a longitudinal axis therewith, such that each portion of a particle beam, received by a relevant one of the plurality of plate apertures, enters a corresponding focusing aperture through which it is focused onto a said surface of material on which it is desired to write.

The size of each focusing aperture is in the range of between 20 nm and 200 μm, but is preferably larger than the size of the corresponding plate aperture.

The focusing means preferably comprises three spaced apart electrically conductive elements. Each electrically conductive element may be electrically biased relative to its adjacent electrically conductive element. Each electrically conductive element may also be spaced apart from its adjacent electrically conductive element by a plurality of electrical insulators interspaced with the plurality of electrically conductive elements.

Also according to the present invention there is provided direct write particle beam apparatus comprising a particle beam source and a mask as described in the preceding six paragraphs.

The particle beam source may be adapted to provide a particle beam incident on the aperture plate having energy in the range from 20 eV to 100 keV, or preferably in the range from 150 eV to 5 keV, or more preferably approximately 50 eV.

From a single particle beam the mask provides a large number of beams, each capable of being focused to a spot size below 10 nm whilst being also capable of writing at speeds which exceed the single beam machine by factors corresponding to the increased number of beams. The present invention is therefore capable of producing nanopatterned surfaces of practical areas in relatively rapid timescales. Furthermore, the apparatus of the present invention is also relatively inexpensive to produce compared with currently available single beam apparatus.

The present invention provides an intense electron/ion beam, from the electron/ion source, which is incident on the mask. Portions of the incident beam enter each of the plurality of plate apertures and then into the corresponding focusing aperture through which it is focused to a point beyond the mask at which nanoscale features may be formed at the focal point where the material surface is positioned.

The simplest device is one in which the metal conducting mask consists of a collimator with an array of nanometer or micrometer diameter holes in it. Each part of the beam which passes through the first collimator is focused by an arrangement of three (or more) metal conducting apertured plates which act like an array of nanoscale/microscale cylindrical electrostatic lenses (einzel lenses). This will produce an array of focused dots on the image plane of the material surface (substrate target) downstream of the mask so that by moving the substrate laterally using a piezo arrangement, as is commonly employed in scanning tunneling microscopy (STM), it is possible to trace out a pattern on the surface. For this arrangement the pattern has to be invariant under translation in two orthogonal directions by an amount equal to the regular spacing between the apertures.

The apparatus comprises an intense high-brightness source of electrons or ions. Standard high brightness sources are of either the liquid metal or duoplasmatron type, for voltages around 300 eV (in vacuum). The beam may be focused using a standard electrostatic (or magnetic) lens so that the beam spot just covers the mask area. If the focal length of the source lens is relatively large compared with the focal length of the einzel lens micro-array then the input to each einzel lens is effectively a circular bundle of parallel electrons/ions with a diameter equal to the aperture in the first layer of the mask. It is then possible to focus each bundle using one element of the array down to sizes which depend on the size of the aperture and the focal length of the micro-lens. For a practical system this focal length of the mask assembly needs to be greater than around 50 um and it is then possible to focus each of the multiple beams below about 10 nm diameter especially if the aperture is sufficiently small.

The present invention will now be described, by way of example, with reference to the accompanying drawings, in which:

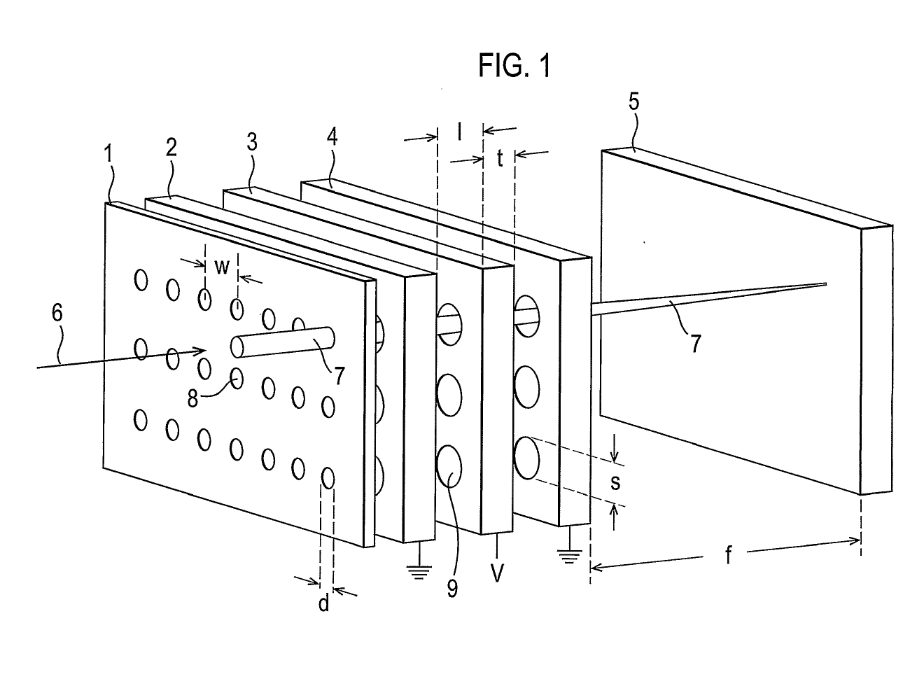

FIG. 1 is an isometric schematic drawing of the mask according to the present invention; and

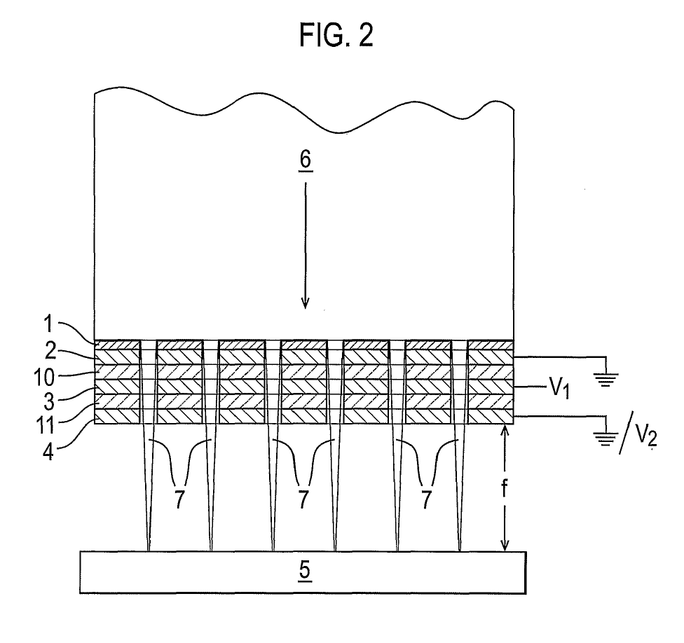

FIG. 2 is a sectional drawing of the apparatus according to the present invention including the mask of FIG. 1.

Referring to FIGS. 1 and 2, a small rectangular portion of a focusing metal mask comprises an aperture plate 1 and focusing means comprising three electrically conductive elements in the form of isolated metal plates 2, 3 and 4 underlying the mask. The aperture plate 1 comprises a plurality of apertures 8. The apertures 8 in the aperture plate are typically 1 μm in diameter d. The focusing means also comprises a plurality of focusing apertures 9, each plate aperture 8 having a corresponding focusing aperture 9 which shares a longitudinal axis therewith. Each focusing aperture forms an einzel lens structure, such that the plurality of focusing apertures forms an einzel lens array. Each focusing aperture 9 is larger than the its corresponding plate aperture 8 and is typically about 3 μm and separated by a distance w of about 50 μm from adjacent apertures. Such a mask can be manufactured using for example laser machining methods. A complete mask might be a square of area 5 mm×5 mm and have about 10000 separate beams. Thus, it is possible for the instrument to pattern this area (5 mm×5 mm) by scanning lateral distances of only 50 μm in each of the two directions instead of the 5 mm needed to cover this area using a single beam. The simplest einzel lens is a three-element system with the same aperture size in each of the metal conducting elements 2, 3 and 4. Alternatively, other sized masks may be used such as, for example, masks having an area of 10 mm×10 mm providing 1000000 separate beams. Each isolated metal plate is of thickness t of the micron order and is separated by dimension I also in the micron order. The outer two electrically conductive plates 2, 4 are at earth potential and the central element has a voltage V₁ applied to it to give a focus at the required distance f from the sample 5. Alternatively, the electrically conductive plate 4 (closest to the surface of the material sample) may have a second voltage V₂ applied to it to alter the acceleration of the particles passing through and the focusing of the beam. The three electrically conductive plates 2, 3 and 4 are electrically isolated from each for example by constructing the system in the form of alternative layers of metal (2, 3 and 4) and insulator material (10 and 11) such as, for example, three layers of metal interspaced with two layers of insulating material.

In FIG. 1, the effect of a single focusing aperture (lens) of the array on a circular bundle of electrons/ions beam 7 defined by the plate apertures, acting as collimators, is shown with the incident beam direction marked by the arrow 6. FIG. 2 shows the effect of the plurality of focusing apertures to form a corresponding plurality of beams 7.

If the mask is used for ions to make a multiple-beam milling machine then it is clear that the aperture plate of the mask will be gradually sputtered away. Depositing atoms from a standard atomic deposition system onto the front surface of the aperture plate 1 at periodic intervals can solve this problem. Alternatively, the energy of the beam before the aperture plate collimator can be reduced so that the sputtering from the front surface is minimal. An acceptable reduced beam energy would typically be about 50 eV. In this arrangement the electrically conductive plate elements 2, 3 and 4, of the lens, and the sample are placed at various increasing voltages so that the ions are accelerated, as well as being focused, as they pass through the system. The final energy is chosen as being around 300 eV so as to be able to effectively sputter atoms from the sample 5. Scanning of the beams over the sample can be achieved by moving the sample laterally using piezo devices (which are attached to the sample) as commonly employed to move the sample in near field microscopy such as STM.

This device described above can be made more general so that it is possible to image different patterns on the surface other than an array of small spots. Making the aperture plate in the form of a ‘microscale stencil’ does this. For example this pattern may be a series of slots in the first plate rather than circular apertures. If the subsequent electrically conductive plate focusing elements also have a matching pattern, then the image will reproduce the pattern but with the dimensions considerably reduced in the focusing direction. Thus a series of slots of a certain width (in the micrometer range) will be focused to produce a series of nanometer wide lines on the focal plane. For this arrangement the three electrically conductive plate focusing elements will also be a series of overlapping slots but of a greater width than the slots in the first defining aperture plate. Using this arrangement it is possible to make a series of nanometer scale wires on a surface by sputtering metal from a thin layer on a suitable substrate using these focused ion beams. This can be done for any separation of wires by scanning only in one direction (normal to the wire direction) rather than two directions needed when circular holes are used. Indeed it is then only necessary to shift the sample in discrete steps normal to the wire direction. During this shift it will be necessary to prevent the beam passing through the aperture plate stencil. This can be done by applying a large retarding voltage to the aperture plate stencil so that the beam is effectively repelled during the lateral shift of the sample.

It is also possible make patterns, such as printed circuits with nanowires, which are not necessarily invariant under translations in two (orthogonal) directions of a distance w (FIG. 1). This is done by controlling separately the beam which passes through each hole in the aperture plate using a series of electrical gates placed behind each aperture in the aperture plate. Behind the mask is an additional microcircuit plate which is an array of thin (conducting) metal structures on an insulating support plate similar to a miniature printed circuit board. The conducting structures on the board consist of an array of thin metal annular rings of outside diameter somewhat smaller than the spacing between the mask holes w. The inner diameter of the annuli are the same as the holes in the aperture plate and the board is positioned directly behind the aperture plate so that the centre of each small annulus coincides with an aperture in the collimating array (aperture plate). Holes are also made in the insulating support plate so that the beam passing through the aperture plate collimator can pass through to the focusing aperture. The voltage on each annulus can be controlled separately by a microcircuit on the insulating support plate. When a sufficiently large voltage of the correct polarity is applied to an individual annulus on the backing support plate then a reverse field is set up which prevents the ions from passing through the associated (concentric) aperture in the aperture plate. By separately controlling the voltages on these plates (using a small computer) during scanning it is possible to write any 2D pattern on the target substrate.

1. A mask for use with a particle beam source, said mask comprising an aperture plate having a plurality of apertures therein, each aperture adapted to receive a portion of a particle beam incident on the aperture plate, and focusing means operable to focus each said portion of a said particle beam onto a surface of material on which it is desired to write.

2. A mask as claimed in claim 1 wherein the focusing means is operable to focus each portion of particle beam to a diameter of approximately 10 nm, or less.

3. A mask as claimed in claim 1 wherein each plate aperture is in the range of between 20 nm and 200 μm,

4. A mask as claimed in claim 3, wherein each plate aperture is approximately 1 μm.

5. A mask, as claimed in claim 1, wherein the focusing means comprises a plurality of spaced apart electrically conductive elements disposed to underlie the aperture plate in parallel arrangement therewith, said focusing means having a plurality of focusing apertures, extending through the electrically conductive elements, each focusing aperture corresponding to one of the plurality of the plate apertures and sharing a longitudinal axis therewith, such that each portion of a particle beam, received by a relevant one of the plurality of plate apertures, enters a corresponding focusing aperture through which it is focused onto a said surface of material on which it is desired to write.

6. A mask as claimed in claim 5, wherein, each focusing aperture is in the range of between 20 nm and 200 μm.

7. A mask as claimed in claim 6, wherein each focusing aperture is approximately 3 μm.

8. A mask as claimed in claim 5, wherein each focusing aperture is larger than the corresponding plate aperture.

9. A mask as claimed in claim 5, wherein the focusing means comprises three spaced apart electrically conductive elements.

10. A mask as claimed in claim 5, wherein each of the electrically conductive elements is electrically biased relative to its adjacent electrically conductive element.

11. A mask as claimed in claim 5, wherein the electrically conductive elements are spaced apart by a plurality of electrical insulators interspaced with the electrically conductive elements.

12. A direct write particle beam apparatus comprising a particle beam source and a mask as claimed in claim 1.

13. A direct write particle beam apparatus as claimed in claim 11, wherein the particle beam source is adapted to provide a particle beam incident on the aperture plate having energy in the range from 20 eV to 100 keV.

14. A direct write particle beam apparatus, as claimed in claim 12, wherein the particle beam source is adapted to provide a particle beam incident on the aperture plate having energy in the range from 150 eV to 5 keV.

15. A direct write particle beam apparatus as claimed in claim 12 wherein the particle beam generator is adapted to provide a particle beam incident on the aperture plate having energy of approximately 50 eV.
